(19) United States
(12) Patent Application Publication
(10) Pub. No.: US 2023/0260296 A1
(43) Pub. Date: Aug. 17, 2023

(54) Tire Pressure Monitoring System Tool (TPMS) With Tire Indicia Recognition

(71) Applicant: ATEQ Corporation, Livonia, MI (US)

(72) Inventors: Bruno Rousseau, Cupertino, CA (US); Grant Barnes, Oak Park, MI (US)

(21) Appl. No.: 18/168,664

(22) Filed: Feb. 14, 2023

Related U.S. Application Data
(60) Provisional application No. 63/310,680, filed on Feb. 16, 2022.

(51) Int. Cl. G06V 20/62; G06V 30/10; G06V 30/146; G07C 5/08

(52) U.S. Cl. CPC G06V 20/62; G06V 30/10; G06V 30/146; G07C 5/0866

(57) ABSTRACT

A diagnostic tool for a vehicle includes an imaging device operable to acquire an image of tire characters positioned on an exterior of a vehicle tire. The diagnostic tool includes an optical character recognition (OCR) module configured to identify the tire characters of the tire and an assistance module configured to assist a user to acquire the image of the tire characters with the imaging device. In one example, the diagnostic tool includes a database of vehicle tire information and a database of TPMS tire sensor information. The diagnostic tool is configured to identify a compatible TPMS tire sensor based on the identified tire resulting from the image of the tire characters. In one example, the diagnostic tool is a TPMS tool configured to communicate with a TPMS tire sensor in the vehicle tire.

### CROSS-REFERENCE TO RELATED APPLICATION(S)

This application claims priority benefit to U.S. Provisional Patent Application No. 63/310,680, filed Feb. 16, 2022, the entire contents of which is incorporated herein by reference for all purposes.

### TECHNICAL FIELD

This disclosure relates to the field of automotive diagnostic tool devices. In one example, the tool is configured to communicate with tire pressure monitoring systems (TMPS) of automotive vehicles.

### BACKGROUND

Diagnostic tools configured to assist vehicle manufacturers and vehicle service technicians are used for a wide variety of vehicle metrics to check for proper functioning of vehicle components and systems. Examples of these systems include vehicle batteries, fluid levels, and vehicle tires for proper air pressure. With the increase in vehicle electronics and the complexity of vehicle systems and operation, checking the status and proper functioning of these electronic systems and components is more challenging and time consuming.

Tire pressure monitoring systems (TPMS) have been mandatory on passenger vehicles having pneumatic tires in the US and Europe for several years. TPMS systems generally consist of a TPMS sensor in the valve stem of a pneumatic tire which monitors various conditions of a tire, for example tire air pressure and temperature. In a fundamental mode of operation, if a measured tire air pressure drops below a predetermined value, the TPMS sensor will send a wireless signal which is received by the vehicle's electronic control unit (ECU), or other vehicle system, to alert a driver of the measured low tire air pressure before the tire is damaged and to maintain safe driving conditions.

Each TPMS tire sensor typically includes its own unique identification alphanumeric code so the vehicle ECU can distinguish between the typical four tires on a passenger vehicle and further alert a driver which vehicle tire may be experiencing conditions outside of an acceptable range.

With increasing use of TPMS in vehicles, many different manufactures of TPMS sensors have entered the marketplace. Vehicle ECU's are not universal in their communication protocols and/or ability to use any TPMS sensor to replace an original equipment TPMS sensor on the new vehicle. For example, original equipment manufacturers (OEM's) typically use one of two frequencies which require the TPMS sensor to communicate at that frequency in order to operate. Further, the variability of tire manufacturers and the many different types and sizes of tires, and valves used with the different tires, adds to the complexity of determining the compatibility or proper TPMS sensor to use when a TPMS sensor needs to be replaced. The combination of hundreds of different vehicles (e.g., different make, model and year), hundreds of different tires (e.g., different make, model, year and size), the many different TPMS sensors (e.g., make, model, recommended compatibility with certain tire brands and tires), make it very laborious and time consuming for vehicle service garages to quickly determine tire metrics, tire valve metrics, and/or which TPMS sensor is appropriate for a particular vehicle, tire, and/or tire valve.

Use of TPMS tools, hand-held tools which communicate with the vehicle TPMS sensors, are available and widely used by OEM's and vehicle service facilities. These tools are operable to transmit an initial signal which “wakes” a nearby TPMS sensor which is typically in an inactive state to preserve the TPMS sensor battery life. Once awakened, the TPMS sensor emits data signals regarding metrics of the present state of the tire (e.g., the TPMS sensor specific identification number, the tire air pressure, tire temperature, battery life, and other metrics). The TPMS tool receives, decodes, and interprets the TPMS sensor data in a form readable by a service technician or user. More sophisticated TPMS tools include internal databases which include, for example, information on major OEM manufacturers vehicles (e.g., make, model, and year of vehicles). One example of a TPMS tool manufacturer is ATEQ Corporation, the assignee of the present invention.

As noted above, even with modern TPMS tools, the identification of the proper TPMS sensor for use in a particular vehicle is a laborious and time consuming task for service technicians. It would be advantageous to provide a TPMS tool with the capability to assist a technician to quickly identify the make, model and year of the tires on a vehicle to determine important information on the tires to assist in related tire service and TPMS services, including but not limited to, which can be used to quickly identify the proper TPMS sensor to use for that vehicle and tire. It would be further advantageous for a TPMS tool to assist users in quickly reading the indicia (e.g., information provided on the exterior of the tires) to assist users in identifying tire important tire metrics for services related to vehicle tires.

### SUMMARY

Disclosed herein is a diagnostic tool for a vehicle. In one example the tool includes a housing having a user interface including a visual display panel. An imaging device is in communication with the visual display panel and is configured to acquire an image of indicia including characters positioned on the exterior of a vehicle tire. The diagnostic tool includes an optical character recognition (OCR) module that is configured to identify the characters of the indicia acquired in the image. In one example, the diagnostic tool includes a database of tire pressure monitoring system (TPMS) tire sensor information including TPMS tire sensor identification information. In the example, the diagnostic tool includes a database of vehicle tire information including vehicle tire identification information. The diagnostic tool is configured to identify the vehicle tire from the database of vehicle tire information based on the identified characters in the indicia in the image and identify a compatible TPMS tire sensor for the identified vehicle tire from the database of TPMS tire sensor information.

In one example, the diagnostic tool is a TPMS tool for use with a TPMS including at least one TPMS sensor, typically four TPMS sensors for common automobile passenger vehicles. The example TPMS tool is useful for vehicles having more or less than four wheels and associated TPMS sensors, for example on a two-wheel motorcycle or commercial vehicle having more than four wheels and associated TPMS sensors.

In one example, the TPMS tool includes a housing, a tire sensor trigger signal generator, an antenna, a user interface, a receiver, an imaging device operable or configured to acquire an image, for example the identification characters on an exterior of a tire, an optical character recognition module to read the tire characters, and an assistance module to assist or guide a tool user to acquire the image of the tire characters for use by the TPMS tool.

In one example of the TPMS tool, the tool includes a control system having a data memory storage device operable to store at least one of a database of TPMS tire sensor information or a database of vehicle tire information. In one example, the database of TPMS tire sensors includes information on a plurality of different TPMS sensors including, for example, the make, model and year of commonly available TPMS sensors. In one example, the database of vehicle tires includes the make, model, and size of commonly available automotive tires.

In one example diagnostic or TPMS tool, the imaging device is positioned within the housing of the tool and includes a camera operable to take or acquire still or continuous images (i.e., video) of subject matter within the viewing range of the imaging device. The imaging device is in communication with the control system data memory storage device to store the acquired image, for example, the tire characters used to identify the specific tire.

In one example of the diagnostic or TPMS tool, an optical character recognition (OCR) module is positioned within the housing of the tool and in communication with the control system and imaging device of the tool. The OCR module is operable to analyze or “read” the tire characters for use by the tool for comparison to the information database of tires to identify the tire captured by the acquired image.

In one example diagnostic or TPMS tool, the assistance module is positioned within the housing of the tool and is in communication with the control system of the tool. The assistance module is operable to assist or guide the tool user to position the tool, more specifically the imaging device of the tool relative to the tire characters, to quickly and efficiently acquire a suitable image of the tire characters for use by the OCR module to read the tire characters and identify the tire based on the tire characters. In one example, the assistance module, in combination with the imaging device, provides an visual indicator to assist the tool user in acquiring the image of tire characters.

In another example of the assistance module of the tool, or as an example of the visual indicator, the assistance module provides a visual overlay on the present or live image generated by the imaging device on the visual display device of the tool. In one example of the visual overlay, the visual overlay provides an oversized outline of a lead character of the tire characters to assist in the alignment of the imaging device relative to the tire characters to aid in acquiring the image of the tire characters. In another example, the visual overlay provides a line positionable by the user below the tire characters to aid in acquiring the image of the tire characters. In another example of the visual overlay, the visual overlay provides a window or box to frame the tire characters to aid in the acquiring the image of the tire characters.

In an example of a method for identifying a vehicle tire, a diagnostic tool is provided and positioned adjacent a vehicle tire. The vehicle tire includes indicia having tire characters on the exterior of the vehicle tire. The method includes capturing an image of the indicia on the exterior of the vehicle tire with an imaging device connected to the diagnostic tool. The method includes reading the tire characters by an optical character recognition (OCR) module connected to the diagnostic tool and identifying the vehicle tire by cross-referencing the tire characters captured in the image and read by the OCR module to a database of vehicle tire information.

In one example of the method, the diagnostic tool is a TPMS tool including a database of TPMS tire sensor information to identify compatible TPMS tire sensors for a vehicle or vehicle tire. On identification of the vehicle tire, the database of TPMS tire sensor information is cross-referenced to identify compatible TPMS tire sensors for the identified vehicle tire.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is schematic representation of an example automobile and a front view of an example of a diagnostic tool in the form of a TPMS tool.

FIG. 2 is a partially cut-away schematic of the TPMS tool shown in FIG. 1.

FIG. 3 is a rear view of the TPMS tool shown in FIG. 1

FIG. 4 is a schematic front view of an automobile tire with an example of tire characters.

FIG. 5 is an enlarged portion of the tire characters of FIG. 4 as displayed by the TPMS tool visual display device including an example visual overlay.

FIG. 6 is an alternate example of FIG. 5 showing an alternate example of the visual overlay.

FIG. 7 is a schematic top view of an example of the TPMS tool in a position to acquire an image of the tire characters of an example tire.

FIG. 8 is a schematic flow chart of an example of a method for identifying a vehicle tire.

FIG. 9 is a schematic diagram of an example control system for a TPMS tool.

### DETAILED DESCRIPTION

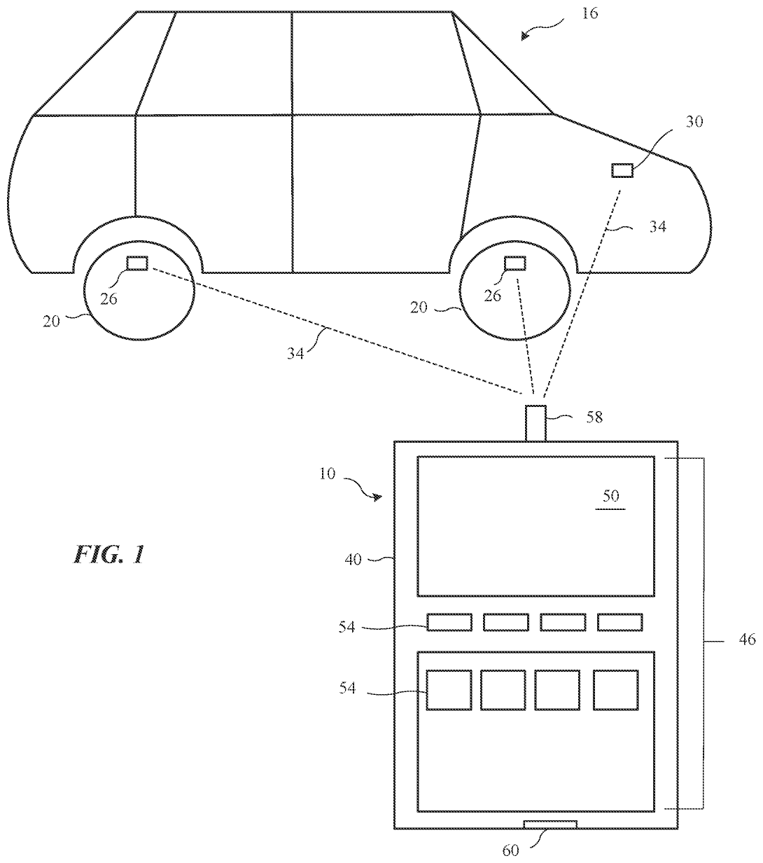

Referring to FIGS. 1-9, examples of a diagnostic tool and a method for identifying a vehicle tire. In one example, the diagnostic tool is in the form of a TPMS tool (described further below) useful in both serving as a TPMS tool to communicate with the vehicle TPMS and TPMS tire sensors, but to also to assist a user to quickly identify the tire, or tires, of a vehicle. The identification of the tires of a vehicle is useful in the inspection and/or maintenance of a vehicle TPMS, for example determining what type of TPMS tire sensor is installed in the identified tire without having to remove the TPMS tire sensor, or replacing the TPMS tire sensor. Although the diagnostic tool is largely described herein as useful on common automotive passenger vehicles, it is understood that the diagnostic tool is useful for other applications, for example, commercial vehicles (e.g., semi-tractor trucks and trailers and heavy-duty trucks having many tires), other forms of recreational vehicles (RVs, motorcycles, mopeds, ATVs, bicycles), other consumer products and/or recreation devices including pressurized air (e.g., water sport tubes, inflatable pools), and other devices known by those skilled in the art.

Referring to FIGS. 1-3, an example a diagnostic tool 10 is shown. In the example, the diagnostic tool 10 is shown in the form of a TPMS tool capable of communicating with vehicle TPMS described above and further below (the diagnostic tool 10 referred simply as “tool”). In one example of use, tool 10 is useful with a vehicle 16, having one or more tires 20, each tire 20 including a TPMS tire sensor 26 positioned in the interior of the tire in communication with the internal air pressure of the tire. The TPMS sensor 26 includes components and operates in a conventional way as known by those skilled in the art and is not further described here. The exemplary vehicle 16 includes an electronic control unit (ECU) 30 which is operable or configured to communicate with the TPMS sensors 26 in a conventional way as known by those skilled in the art and is not further described here.

The example tool 10 is operable or configured to selectively communicate with the TPMS tire sensors 26 and the ECU 30 of the vehicle through transmission and receipt of radio frequency signals 34 including data transmitted by the tool 10, and received from either or both of the TPMS sensors 26 or the vehicle ECU 30 which is further described below. Although described and illustrated in the form of a TPMS tool, it is understood that diagnostic tool 10 may exclude hardware and functions relating to TPMS (e.g., the tool 10 may include the above and below described hardware and functions to capture the image of the indicia and identify the vehicle tire for other purposes than relating to TPMS, or identification of suitable TPMS tire sensors 26).

As best seen in the FIG. 1 example, tool 10 includes a housing 40 which serves to position and secure interior components as further described below and provide a user interface 46 providing information to a user, as well as allowing a user to input information into the tool 10 through the user interface 46. In one example, the housing 40 is sized to be a hand-held device, for example in the size and/or configuration of mobile phone or tablet device (e.g., smart phone, iPAD®, Microsoft Surface) or similar portable, programmable smart devices. In one example, user interface 46 includes a visual display panel or device 50.

In one example, the visual display panel 50 includes a visual screen which produces text and/or visual images for a user to view with the eye. Common forms of visual display devices or screens include liquid crystal display (LCD) devices (e.g., TFT, IPS), LED, OLED, AMOLED, and super AMOLED. These examples of display devices may include capacitive touch screen features or capabilities. Other visual display panels 50 suitable for the specific application and environment known by those skilled in the art may be used.

As best seen in the FIG. 1 example, the user interface 46 may also include one or more push buttons 54 wherein a user may input information or navigate information or menus displayed on the visual display panel 50. The buttons 54 may take many forms, for example single or multiple buttons (e.g., selection or navigation arrow buttons) for different features or functions, an alphanumeric keyboard, or other buttons depending on the application as known by those skilled in the art. In one example of tool 10 in the form of a tablet, no physical push buttons 54 may be used. In the tablet configuration, the visual display device 50 may constitute most of the user surface of the tool 10 and buttons or areas may be displayed on the visual display panel 50 or screen for activation or navigation by the user. Other sizes, shapes, configurations, features and/or functions of the housing 40, and user interface 46, suitable for the particular application, environment, and/or performance requirements known by those skilled in the art may be used.

Still referring to FIGS. 1-3, tool 10 includes an antenna 58 connected to the housing and in communication with the control system, for example an internal transmitter and receiving device, discussed further below. In an alternate example (not shown), antenna 58 may be completely concealed within the housing 40 (i.e., not extending outward from the housing 40 as shown).

Tool 10 further includes a communication port 60 in the housing 40 in communication with the control system of tool 10. In one example, the port 60 is a USB port for connection of electronic and/or data communication cables allowing the tool 10 to send and receive signals with the vehicle 16 communication system and/or other electronic devices.

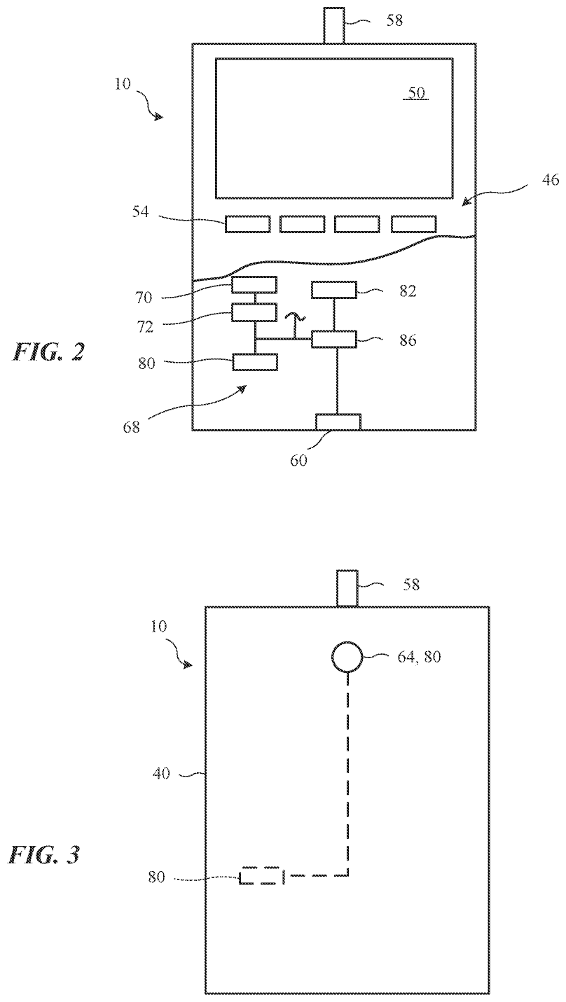

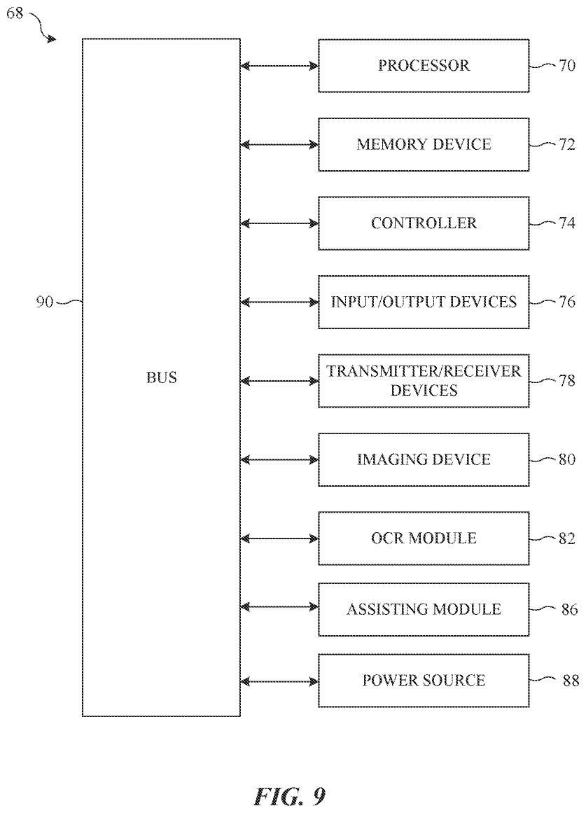

Referring to FIGS. 1, 2 and 9, as best seen in FIG. 9, FIG. 9 shows a block diagram of the control system 68 operable to receive inputs and data, process and store data, and display and/or transmit data in the many ways described herein. In the FIGS. 2 and 9 example, control system 68 includes one or more of a processor 70, a memory storage device 72, a controller 74, input and/or devices 76, transmitter and/or receiver devices 78, an imaging device 80, an optical character recognition (OCR) module 82, an assistance module 86, a power source 88, and a communication bus 90.

In the FIG. 9 example, the processor 70 is any type of device that is able to process or manipulate information, including devices that are currently known or that may be developed in the future. In one example, the processor 70 is a conventional central processing unit (CPU). A single processor or multiple processors equivalent to the processor 70 may be used.

The memory storage device 72 may be used to temporarily, or permanently, store data or information for use by the processor 70. The memory device 72 may include both random access memory (RAM) and read only memory (ROM). The memory storage device 72 may store operating systems, software, applications, and/or preprogram instructions that can be executed by processor 70. Examples of the memory storage device 72 include a hard disk drive or a solid state drive. Other forms of memory devices may be used.

The controller 74 may include one or more control devices operable with the other tool 10 devices described herein, for example a programmable logic controller (PLC). In one example, the controller 74 monitors the inputs to the user interface 46, for example the user providing inputs through buttons 54 or the imaging device 80 acquiring an image for processing by the processor 70 as further described below. Alternate or additional forms of controller 74 may be used.

The input/output device 76 may include any input device that is operable or configured to generate computer or control device interpretable signals or data in response to user interaction or other predetermine action or stimulus on the input device. As examples, the input device may be or include the push buttons 54, touch-sensitive panels or displays as described above for visual display device 50, the imaging device 50 described further below, microphones and other similar devices known by those skilled in the art.

The input/output device 76 may further include output devices including any device that is operable to relay or convey information that may be perceived by a user or other control system component. As examples, the output device may be or include the visual display device 50 screen described above, light emitting diodes (LED), audio speakers, and haptic output devices. Other types of devices may be included in the output devices as known by those skilled in the art.

Examples of the transmitter and receiver devices 78 include devices for transmitting and/or receiving signals or data between the control system 68, other electronic devices, for example the TPMS sensor 36 and/or the ECU 30. The transmitter and receiver devices 78 may be operable to send and/or receive signals and/or data over predetermined conventional communication networks and/or wireless communication protocols. In one example, the transmitter device includes a trigger signal generator operable to send a tire trigger signal to an adjacent tire including a tire sensor to “trigger” or awaken the tire sensor whereby the tire sensor transmits a signal including detected by the tire sensor from the tire. In one example, the transmitter and received devices may send and/or receive signals through antenna 58. The transmitter and receiver devices 78 may also be selectively hard wire connected to other electronic devices and vehicle systems through communication port 60 by a cable (not shown). Other transmitter and receiver devices 78 known by those skilled in the art may be used.

Examples of the power source 88 may include a rechargeable battery positioned in the housing 40 in communication with the control system 68. In an alternate example, an alternating current power cable may be connected to the housing 40 through a charging port (not shown). Other sources used to provide electrical power to the tool 10 may be used.

The bus 90 is a conventional data communications bus that is operable to transfer signals and/or data between the described tool control system devices shown in FIG. and described herein. A single bus or multiple buses may be used. The bus 90 may include a bus interface that allows other devices, internal or external, to connect to the bus 90. Other types of buses and configurations known by those skilled in the art may be used.

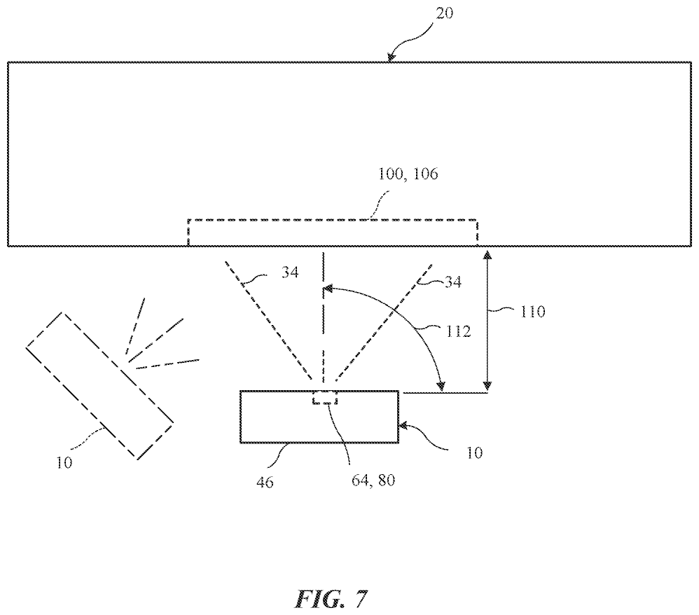

Referring to FIGS. 2, 3, 4 and 7, tool 10 and control system 68 includes the imaging device 80 including an imaging lens 64 as best seen in FIGS. 3 and 7. In one example, the imaging device 80 is operable or configured to acquire an image of indicia 100 on the exterior of tires 20. In one example indicia 100 includes tire characters 106 as further described below. In one example, imaging device 80 includes a camera operable or configured to take digital images of an object, for example tire characters 106. The camera includes the lens 64 which is positioned on the back side of the housing 40 opposite the user interface 46. It is understood that lens 64 may be positioned in an alternate position or surface of housing 40. The imaging device 80 is positioned within housing 40 and is in communication with the control system 68, for example the processor 70, the OCR module 82, the assistance module 86, and other control system devices described through bus 90.

In one example of the imaging device 80 of tool 10 in the form of a camera, imaging device 80 functions similar to a digital camera, for example in common electronic devices, for example smart phones and tablets. When activated, for example through the user interface 46 by the user, the camera is operable to view or vision objects within its range of vision and display in real time the object in the range of vision on the visual display device 50 in order for the user to align and/or focus on the intended object, for example tire characters 106 discussed further below. Once the intended object is in focus, the user can provide an input to the tool 10 through the user interface 46, for example pressing a button 54, to acquire or capture a still, single image of the object, for example tire characters 106 for storage in the memory storage device 72. In an alternate example, the imaging device (i.e., camera) may operate as a video camera wherein the image of the object in the range of vision of the lens 64 is continually recorded and stored in the memory storage device 72 as described for a still image until the user provides an input through the user interface 46 to stop recording.

In an alternate example, imaging device 80 may operate similar to a bar code or QR code reader wherein the camera is initially activated by the user through the user interface 46, but automatically acquires or captures a still image when preprogrammed software stored in memory storage device 72 determines that a suitable image is in the range of vision and is in suitable focus for the OCR module to analyze and interpret the acquired image and object therein, for example tire characters 106 discussed further below. In one example, the above-described image device 80 includes an autofocus feature that may be used to automatically zoom in or out to automatically place the object, for example tire characters 106, in proper focus to acquire the image.

In the example tool 10, imaging device 80 may include additional features that are common to digital camera or digital video recording devices. In one example, imaging device 80 may include autofocusing features and zoom or enlargement features described above, aperture features, and other devices and features common in digital imaging devices, for example smartphones and tablets. Imaging device 80 may further include illumination devices (not shown) to provide additional illumination in the range of view of the imaging device 80. Alternately, tool 10 may include a separate illumination device, for example a LED connected to the housing 40 positioned in the rear of the housing, which may be turned on and off by the user through the user interface 46. It is understood that imaging device 80, and lens 64 may be devices other than conventional digital cameras or video recording devices, and may include other configurations, and functions than those described to suit the particular application and environment as known by those skilled in the art. For example, although shown as a single lens 64, multiple lenses 64 may be used. It is further understood that the imaging device 80 is useful to acquire images other than tire indicia 100, for example tire characters 106, and may be used to acquire images of other objects that are commonly interacted with by tool 10, for example imaging TPMS sensor identification indicia positioned on an exterior of the TPMS sensor 26, for example bar codes, and other vehicle identification information, for example vehicle identification numbers (VIN), and other objects or indicia known by those skilled in the art.

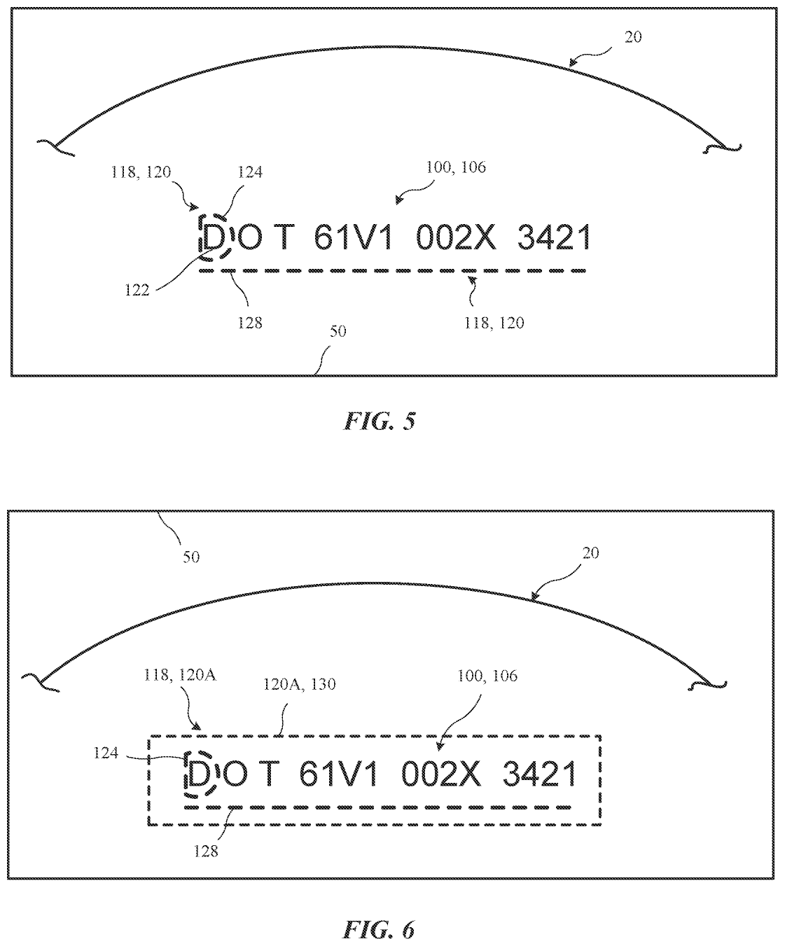

Referring to the FIGS. 5 and 6 examples, one application of use for tool 10 is for assisting a user to quickly and efficiently identify the important features and characteristics of tires 20, for example at least one of the tire 20 make, model, type, size, date of manufacture, and/or the location of manufacture of tire 20, to assist the user in related tire services, for example inspection or replacement of TPMS sensors 26. For example, the US Department of Transportation (DOT) requires tire manufacturers to include indicia 100, for example tire characters 106, on the exterior of the tires 20 sold in the United States. Through use of the tool 10, a user can acquire an image of the indicia 100, for example tire characters 106, and through recognition and identification of the tire characters 106 through OCR module 82, accurately and more efficiently complete related tire service tasks, for example inspection or replacement of TPMS tire sensors 26.

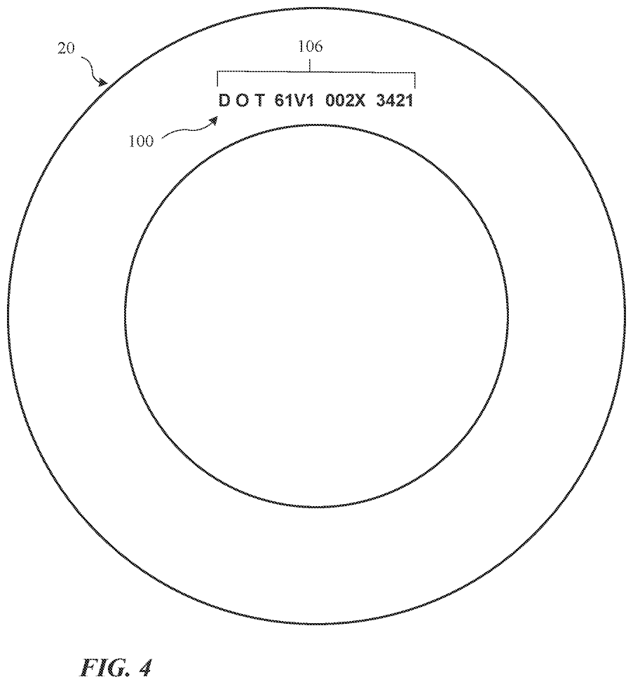

In the FIGS. 4-6 examples of tire characters 106, tires 20 sold in the United States include a string or listing of alphanumeric characters (e.g., a combination of letters and numbers) to identify the above described characteristics and/or history of the manufacture of the specific tire 20. In the example, the tire characters 106 begin with a “DOT” (Department of Transportation) including a lead character 122 (“D” in the illustrated example). In the FIGS. 4-6 example, the tire characters 106 are shown in a substantial straight line (e.g., not following the curvature of the tire 20). It is understood that the tire indicia 100, and/or the tire characters 106, may be molded into the exterior of the tire 20 in a curved or arc orientation (e.g., following the curvature of the sidewall of the tire 20). It is understood that the tire indicia 100, and/or tire characters 106, may be different forms or strings of characters or indicia, presented in different fonts or languages, include different country or geographic requirements, information or performance standards, and/or represent different information about the characteristics or origin of the tire 20 as understood by those skilled in the art. It is further understood that the indicia 100 may be on products different than tires 20 as described above.

Referring to the example of tool 10 as best seen in FIG. 7, the tool 10, for example in control system 68, includes an assistance module or device 86. In one example, assistance module 86 is operable or configured to assist a user to position the tool 10 relative to the tire 20, for example tire indicia 100, to acquire or take a proper or suitable image by the imaging device 80 as described above. In one example, the assistance module 86 includes a distance measuring device or sensor operable to a measure or gauge a distance 110 from the housing 40 or lens 64 in order to assist the user to position the tool 10 at a suitable distance from the tire 20 (e.g., the tire indicia 100 or tire characters 106). In one example, a laser distance detector or sensor (not shown) may be positioned in the housing 40 in communication with the control system 64 and is operable to project a laser beam at an object (e.g., tire 20). The laser detector, in combination with the control system 68, for example software stored in the data memory storage device 72, is operable or configured to measure and calculate the distance 110 between the housing 40, or lens 64, and the tire indicia 100. Preprogrammed and stored software and/or instructions, for example predetermined distances for acquiring suitable images by the imaging device 80, may be compared to the detected distance. In an alternate example, the distance measuring device may operate in a coordinating manner with the above-described autofocusing device or feature of the imaging device 80, or may be integral with the autofocusing device.

In one example, the control system 68 may notify the user whether or when a suitable distance 110 has been achieved to properly acquire the image. In one example of a notification, a visual or audible notification is provided to the user. Examples of a visual notification include a visual icon or message displayed on the visual display panel 50, or a separate illumination device on the housing 40 or user interface 46 (e.g., an LED indicator). One example of an audible notification may include a beep or sound emitted from a speaker (not shown) on the housing 40 or through the user interface 46. Other examples of notifications may be used as known by those skilled in the art.

In one example, assistance module 86 may include an angle measurement device or sensor which assists the user to position the tool 10 or lens 64 at a proper or suitable angle 112 relative to the tire 20, for example tire characters 106. In one example, one or more laser sensor devices described above may be used to measure or gauge the orientation or angle of the tool 10 or lens 64 relative to the tire 20 (an angled tool 10 shown in phantom line positioned at an angle for example). As described for the example distance measuring device, the angle measurement device is in communication with the control system 68, and devices described therein. Similarly, software and/or other preprogrammed instructions and/or predetermined angles may be compared to the angle measurement device data taken and notifications and/or guidance provided to the user to achieve a proper or suitable angle 112 to acquire the image, for example of tire characters 106. Although angle 112 is shown relative to a vertical plane, it is understood that the assistance module 86, and/or the exemplary angle measurement device, is useful for other angles of tool 10 relative to the tire 20, for example relative to a horizontal plane. Other angle measurement devices, sensors, features and/or operations useful to assist the user in positioning the tool 10 at a proper or suitable angle 112 may be included in assistance module 86 as known by those skilled in the art. It is further understood that the described distance and angular measurement devices may coordinatingly work with, or be integral to, other features described above for imaging device 80 (e.g., autofocus and zoom camera features).

In one example of assistance module 86, visual notifications or guidance to the user as to, for example the proper distance 110 and/or angle 112, to position the tool 10 relative to the tire 20 in order to acquire a proper or suitable image of an object, for example tire characters 106, are provided through the user interface 46, for example the visual display panel 50.

Referring to the FIGS. 4-6 examples, assistance module 86 is operable to provide one or more visual indicators 118 to assist the user in acquiring a proper or suitable image, for example of tire indicia 100 (e.g., tire characters 106). In one example, the visual indicator 118 is visible on the visual display panel 50 and is configured to assist the user to align the imaging device 64 with the tire characters 106 of the indica 100 acquired in the image.

Referring to FIG. 5, one example of an indicator 118 is in the form of an overlay pattern 120 (shown in dashed line). In the example shown in FIG. 5, overlay pattern 120 is in the form of a single overlay character letter “D” 124 positioned outside or around a lead letter or character “D” 122 included in the string of tire characters 106 molded into the exterior of the sidewall of tire 20. It is understood that the overlay character 124 may alternately take the form of other alphanumeric letters, numbers, or symbols to suit the particular indicia 100 (e.g., letters other than the “D” illustrated in FIGS. 5 and 6). It is further understood that the overlay character 124 may be used to overlay or surround a different alphanumeric character included in the string of tire characters 106 other than the lead character 122 as illustrated to suit the particular application and tire indicia 100 (or indicia of products or objects other than tires 20 as described above). It is further understood that overlay character 124 may overlay one or more of the tire characters than just a single character as illustrated (e.g., overlay two or all three of the “DOT” characters).

In the FIG. 5 example, the example overlay pattern 120 also includes an overlay line 128 (shown in dashed line) which is positioned and oriented below the character overlay 124 as generally shown. The example overlay line 128 may be sized or of a length to substantially underline the entire length of the string of tire characters 106. In an alternate example (not shown), the overlay line 128 may extend for only a portion of the length of the string of tire characters 106. As described above, although the illustrated tire characters 106 are shown substantially straight or linear, it is understood that the tire characters 106, and the single overlay character 124 and the overlay line 128, may be curved or arched in a similar manner if the tire characters 106 are molded into the sidewall of the tire 20 are also curved or arched. Although the FIG. 5 example shows use of both of the overlay character 124 and the overlay line 128, it is understood that only one of the overlay character 124 or the overlay line 128 may be used.

Referring to FIG. 6, an alternate overlay pattern 120A is shown. The overlay pattern 120A also includes an overlay window, box, or frame 130 (shown in dashed line) positioned outside of, or around, to enclose or surround the string of tire characters 106 as generally shown. In the example overlay window 130, the length and height of the overlay window 130 is sized to be larger than the entire length of the string of tire characters 106 to “frame” the tire characters to assist the user to quickly and efficiently focus on the tire indicia 100, or tire characters 106, to acquire the image of the, for example, tire characters 106. In alternate examples of overlay window 130 (not shown), the overlay window 130 may only encompass, surround or frame only a portion of the length of the string of tire characters 106. In one example (not shown) the window overlay may only surround the first three characters (i.e., the “DOT” characters).

The overlay window 130 may be alternate configurations other than a closed window or frame as illustrated. For example, the illustrated overlay window 130 upper or lower line (i.e., the FIG. 6 horizontal line portions of overlay window 130) may not be included (e.g., forming an elongated “U” or elongated inverted “U”, respectively, extending along the entire length of the string of tire characters). In an alternate example (not shown), the illustrated overlay window 130 left and right lines (i.e., the FIG. 6 left and right vertical line portions of overlay window 130) may not be included (e.g., the overlay window 130 consists of parallel lines above and below the tire characters 106). In another example (not shown) only one of the left and right vertical lines may be used. It is understood that any combination of the described lines or portions of the illustrated lines forming the overlay window 130 may be used or serve as the overlay window 130. As described above, the overlay window 130 may be configured as a curved or arched window to accommodate curved or arched indicia 100. Although the FIG. 6 example shows use of all of the overlay character 124, the overlay line 128, and the overlay window 130, it is understood that any of the described overlays may singly be used (e.g., without the other described overlays), or used in combination with one or more of the other described overlays, and described variations thereof, to suit the particular application as known by those skilled in the art.

In one example of tool 10 and assistance module 86, the visual indicator 118, for example overlay pattern 120, 120A (collectively referred to as overlay pattern 120 unless otherwise noted), is generated and displayed on the visual display panel 50 as generally illustrated in FIGS. 5 and 6. In one example, the overlay pattern 120 appears on the visual display panel 50 similar to icons or other images commonly displayed in the viewer or visual display of the digital camera, smart phone, or tablet. In one example, the displayed overlay pattern 120 is automatically generated and displayed on the visual display panel 50 when the imaging device 80 is activated or turned on by the user through the user interface 46. In an alternate example, the user interface 46 may include a dedicated button 54 that the user can actuate to turn on and display the overlay pattern 120.

In an alternate example (not shown) a laser or other projection device may be used to project the overlay pattern 120 on the tire 20 (e.g., on the tire indicia 100 or tire characters 106). In one example, a user may activate the projection device and aim or align the projected overlay pattern 120, for example overlay character 124, the overlay line 128, or the overlay window 130 to the appropriate character or area of the tire characters which the user could see or follow in real time in the visual display panel 50. Alternate examples of how to generate and/or display the overlay pattern 120 may be used to suit the particular application and environment as known by those skilled in the art.

In one example of tool 10 and assistance module 86, the assistance module 86 includes a notification to the user that the tool 10 is properly or sufficiently positioned to take a suitable image of the tire characters 26. In one example, the notification may include a visual notification displayed on the visual display panel 50 which alerts the user that the tool 10 or imaging device 80 is sufficiently positioned to acquire a good or quality image of the tire indicia 100 or tire characters 106, for example an image that is suitable for the OCR module 82 to analyze and digitize the tire characters 26 acquired in the image. In another example, an audible notification, for example a beep sound, may be emitted from a speaker positioned on the housing in communication with a sound generating device positioned within housing 40 in communication with the control system 68. Other types or forms of notification may be used as known by those skilled in the art.

In one example, tool 10 includes an OCR module 82 operable or configured to read, analyze, recognize, and/or determine scanned or imaged text, graphics and/or other images and digitize the information or data so it can be stored, searched, edited, displayed or otherwise used in digital processing applications. In the example of tool 10, the OCR module 82 is used to read, analyze, convert and/or store the acquired image of the tire indicia 100, for example tire characters 106 to identify one or more characteristics of tire 20 through the information provided by the tire characters 26. In one example, the OCR module 82 is positioned in the housing 40 and in communication with the control system 68 and hardware or components described herein.

In one example of OCR module 82, once the acquired image of, for example the tire characters, is captured or in view of the imaging device 80, and/or stored in the memory storage device 72, the OCR module analyzes the image, and/or data or text in the image, and converts the data or text, for example the tire characters 106 to digitized form for further use as described herein and further below. In one example, the OCR module 82 includes preprogrammed software and/or instructions stored in the data memory storage device 70 and in combination with the processor 70 and controller 74, executes the preprogrammed instructions to carry out the features, operations and functions described above. Other devices and functions to read, analyze, and convert the data in the acquired image to digitized or digital form may be used as known by those skilled in the art.

In one example of tool 10, tool 10 includes a preprogrammed or stored database of TPMS tire sensor information (e.g., TPMS tire sensors 26) and a database of vehicle tire information (e.g., vehicle tires 20). In one example of tool 10, the database of TPMS tire sensor information and the database of vehicle tire information are stored in the memory storage device 72 of tool 10. Alternately, the tool 10 may include the described communication devices (e.g., transmitter/receivers 78) to communicate with other electronic devices, for example a local personal computer, which includes the described database of TPMS tire sensor information and the database of vehicle tire information. In an alternate example, it is understood that the tool 10, or other electronic device in communication with tool 10, may include only one of the described databases (e.g., either the database of vehicle tire information or the database of TPMS tire sensor information). In one example where the tool 10 does not include TPMS communication capabilities, the tool 10 may include only the database of vehicle tire information used to identify the vehicle tire 20.

In one example of the database of TPMS tire sensor information, the database includes data or information on a plurality of available or commonly used TPMS sensors 26 for use in passenger vehicles. In one example, the information database of TPMS sensors 26 includes the make and model of each TPMS tire sensor 26, as well as vehicle or tire compatibility (e.g., vehicles or tires that the TPMS sensor 26 is recommended for use for proper TPMS functionality with the vehicle and/or tire). Alternately, or in addition to, the database of TPMS tire sensor information may be organized or mapped such that on identification of the TPMS sensor, the vehicles 16 and/or tires 20 that the TPMS tire sensor(s) 26 is compatible for use with may be organized, stored and displayed for the tool 10 user. Alternately, or in addition to, the database of TPMS tire sensor information may be organized or mapped such that on identification of the vehicle tire 20, or the vehicle 16, the TPMS tire sensor(s) 26 compatible for use with the identified vehicle tire 20, or vehicle 16, may be organized, stored and displayed for the tool 10 user.

In one example of the database of vehicle tire information, the information may include the tire size, tire diameter, tire color, tire speed or wear ratings, and/or tire reflectivity. Other or additional information in the database of vehicle tires may include the font of the characters of the tire characters 26, the dimensions or size of the characters of the tire characters, and/or the curvature of the string of the tire characters 26 on the exterior of the tire 20. In one example of an database of vehicle tire information, the database includes data or information on a plurality of available or commonly used tires for use in vehicles described herein. In one example, the database of vehicle tire information includes the make, model, year, size, and/or type of tire 20 as well as vehicle or wheel compatibility (e.g., vehicles or wheels that the tire is recommended for use). It is understood that additional or alternate information or data may be included in the described databases for the TPMS tire sensors and the for the vehicle tires to suit the particular application as known by persons skilled in the art.

In one example of operation of tool 10, the imaged and OCR'd indicia 100, for example tire characters 106, are compared or cross-referenced to the data stored in the database of vehicle tires to identify the specific tire 20 and identify and/or determine other needed information or data about the specific tire 20 stored in the database of vehicle tire information. This identified and/or verified tire information may be used for other tire related services as described herein. In one example of operation of tool 10, the identified specific tire 20 may be compared and/or cross-referenced with the data in the database of TPMS tire sensors 26 to, for example, identify a compatible, recommended or suitable TPMS tire sensor 26 for the identified specific tire 20 or vehicle 16. Other uses of the data stored in the database of TPMS tire sensor information and the database of vehicle tire information may be used to suit the application as known by those skilled in the art. As described above, in one example the database of TPMS tire sensor information and the database of vehicle tire information may be stored in memory in the tool 10. Alternately, the databases may be stored and maintained in a local or central computer or server which the tool 10 can access and communicate with to determine, calculate and/or display on the tool 10 the information described herein.

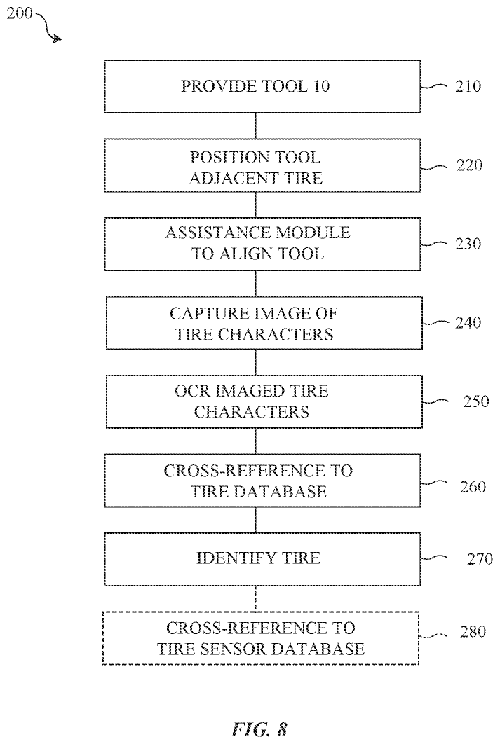

Referring to FIG. 8, an example of a method 200 for identifying a vehicle tire 20 is illustrated. In the example method 200, step 210 includes providing the tool 10 in one of the many tool 10 examples and features described herein. In one example, the tool 10 is a diagnostic tool 10. In another example, the diagnostic tool 10 is in the form of a TPMS tool described above and illustrated.

In example step 220, the tool 10 is activated or powered on and is positioned adjacent to or proximity to a tire 20 where it is desired to identify one or more characteristics of the vehicle tire 20 as described herein. In one example, the vehicle tire 20 includes the indica 100 having tire characters 106 described above. In one example, the user generally positions or aligns the tool 10 so that the tire indicia 100, for example tire characters 106, are generally positioned in the field of view of the imaging device 64 such that the tire characters 106 are visible in the visual display panel 50.

In one example of step 230, the assistance module 86 is activated, or is automatically activated, to assist the user to better or properly align the tool 10 so that a suitable image of the tire characters 106 can be acquired and easily analyzed by the OCR module 82 generally described above. In one example step 230, the visual indicator 118 is used to assist the user to align the tool relative to the tire characters 26 to acquire the image of the tire characters 26. In another example, the overlay pattern 120 is displayed on the visual display panel 50 of the tool 10 to assist the user to position and align the imaging device 80 and/or tool 10 to acquire the image of the indicia 100 or tire characters 106 (or other object or product indicia described herein). In another example, one or more of the distance measurement device or the angular measurement device is used to further assist the user to align or position the tool relative to the tire characters.

In example step 240, the user actuates through the user interface 46 to acquire or capture the image of the indicia 100, for example the tire characters 106, displayed or visible in the visual display panel 50, for example where the tire characters 106 are within and/or aligned with the overlay pattern 120. The acquired image may be stored in the data memory storage device 72.

In exemplary step 250, the OCR module 82, through an actuation by the user through the user interface 46, or automatically according to preprogrammed instructions, reads, analyzes, digitizes, and/or converts the image data of the indicia 100, for example the tire characters 106, to digitized or digital form for further use. The converted or digitized form of the indicial 100, may be separately stored in the data memory storage device 72.

In exemplary step 260, the tool 10 through the control system 68 accesses, compares, and/or cross-references the OCR'd and digitized imaged indicia 100 with data stored in the database of vehicle tire information to identify the specific tire 20 in the captured or acquired image and additional information for the specific tire 20 stored in the information database of tires.

In exemplary step 270, the tool 10 identifies the specific tire 20 from the database of vehicle tire information. As described above, this specific tire information may then be used for services related to the tires.

In an optional step 280, for example if the diagnostic tool 10 is in the form of a TPMS tool, on identification of the specific tire 20, the tool 10 may determine, calculate and/or cross-reference data in the database of TPMS tire sensors to determine a compatible, recommended or suitable TPMS tire sensor 26 for use with that identified specific tire 20 and/or vehicle 16. In one example, the tool 10 may display the identified vehicle tire 20, and/or the identified compatible TPMS tire sensors 26 for the identified vehicle tire 20 or the vehicle 16. This has significant advantages for a user of the tool 10 in the time and accuracy of determination of the vehicle tires 20 specification and compatible TPMS tire sensors 26 for the vehicle tire 20 or the vehicle 16.

It is understood that additional steps, or removal of steps, or the steps may be taken in a different order, may be used for method 200.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A diagnostic tool for a vehicle comprising:
a housing;
a user interface connected to the housing having a visual display panel;
an imaging device in communication with the visual display panel configured to acquire an image of indicia including tire characters positioned on the exterior of a vehicle tire;
an optical character recognition (OCR) module configured to identify the tire characters of the indicia acquired in the image;
a database of tire pressure monitoring system (TPMS) tire sensor information comprising TPMS tire sensor identification information; and
a database of vehicle tire information comprising vehicle tire identification information, wherein the diagnostic tool is configured to identify the vehicle tire from the database of vehicle tire information based on the identified tire characters of the indicia in the image and identify a compatible TPMS tire sensor for the identified vehicle tire from the database of TPMS tire sensor information.

2. The diagnostic tool of claim 1, wherein the database of TPMS tire sensor information further comprises information identifying TPMS tire sensors that are compatible with the vehicle.

3. The diagnostic tool of claim 1, wherein the database of TPMS tire sensor information further comprises information identifying TPMS tire sensors that are compatible with the identified vehicle tire.

4. The diagnostic tool of claim 1, further comprising a data memory storage device positioned in the housing, the data memory storage device including the database of TPMS tire sensor information and the database of vehicle tire information.

5. The diagnostic tool of claim 1, further comprising an assistance module positioned in the housing and configured to assist a user of the diagnostic tool to acquire the image of the indicia positioned on the exterior of the vehicle tire.

6. The diagnostic tool of claim 5, wherein the assistance module further comprises a visual indicator visible on the visual display panel and configured to assist the user to align the imaging device with the tire characters of the indicia to assist the user to acquire the image of the indicia positioned on the exterior of the vehicle tire.

7. The diagnostic tool of claim 6, wherein the visual indicator further comprises an overlay pattern.

8. The diagnostic tool of claim 5, wherein the assistance module is configured to provide a notification to the user through the user interface that the imaging device is properly positioned relative to the indicia in order for the OCR module to identify the tire characters of the indicia.

9. The diagnostic tool of claim 1, wherein the diagnostic tool is a TPMS tool configured to communicate with a TPMS tire sensor in communication with an internal air pressure of the vehicle tire.

10. The diagnostic tool of claim 1, wherein the diagnostic tool is configured to display on the visual display panel the identified TPMS tire sensor that is compatible for the identified vehicle tire.

11. A tire pressure monitoring system (TPMS) tool for use with a TPMS including a TPMS tire sensor, the tool comprising:
a housing;
a tire sensor trigger signal generator positioned in the housing, the trigger signal generator configured to selectively transmit a tire sensor trigger signal;
an antenna connected to the housing in communication with the tire sensor trigger signal generator, the antenna configured to transmit the tire sensor trigger signal to the TPMS tire sensor;
a receiver positioned in the housing configured to receive signals from the TPMS tire sensor;
a user interface connected to the housing;
an imaging device in communication with the user interface configured to acquire an image of vehicle tire characters positioned on an exterior of a vehicle tire;
a data memory storage device positioned in the housing in communication with the user interface and the imaging device, the data memory storage device configured to store in memory a database of TPMS tire sensor information and a database of vehicle tire information including vehicle tire character data positioned on the exterior of the vehicle tire;
an optical character recognition (OCR) module positioned in the housing configured to digitize the vehicle tire characters of the vehicle tire acquired in the image; and
an assistance module positioned in the housing configured to assist a user of the tool to acquire the image of the vehicle tire characters of the tire with the imaging device.

12. The TPMS tool of claim 11, wherein the vehicle tire character data comprises at least one of tire make, tire model, tire diameter, tire color, or tire reflectivity.

13. The TPMS tool of claim 11, wherein the vehicle tire character data comprises at least one of a font of the vehicle tire characters, dimensions of the vehicle tire characters, or curvature of a string of the vehicle tire characters.

14. The TPMS tool of claim 11, wherein the user interface comprises a visual display panel and is configured to display a present image of the vehicle tire characters on the exterior of the vehicle tire, and wherein the assistance module provides a visual indicator on the visual display panel configured to assist the user to acquire the image of the vehicle tire characters positioned on the exterior of the vehicle tire.

15. The TPMS tool of claim 14, wherein the visual indicator comprises an overlay pattern configured to assist the user to position the imaging device relative to the vehicle tire characters to acquire the image of the vehicle tire characters positioned on the exterior of the vehicle tire.

16. The TPMS tool of claim 15, wherein the overlay pattern comprises at least one of an overlay character, an overlay line, or an overlay window relative to the vehicle tire characters.

17. The TPMS tool of claim 11, wherein the assistance module is configured to provide a notification to the user through the user interface that the imaging device is properly positioned relative to the vehicle tire characters in order for the OCR module to recognize the vehicle tire characters.

18. The TPMS tool of claim 11, further comprising a control system in communication with user interface, the imaging device, the data memory storage device, and the OCR module, wherein on acquiring the image of vehicle tire characters and digitization of the vehicle tire characters by the OCR module, the control system is configured to compare the imaged vehicle tire characters with the database of vehicle tire information and identify the vehicle tire from the imaged vehicle tire characters.

19. The TPMS tool of claim 18, wherein on identification of the vehicle tire, the control system is configured to compare the identified vehicle tire to the database of TPMS tire sensor information to identify the TPMS tire sensor compatible for the identified vehicle tire and display the identified TPMS tire sensor that is compatible with the identified vehicle tire on the user interface.

20. A method for identifying a vehicle tire comprising:
providing a diagnostic tool;
positioning the diagnostic tool adjacent a vehicle tire including indicia having tire characters on the exterior of the vehicle tire;
capturing an image of the indicia on the exterior of the vehicle tire with a imaging device connected to the diagnostic tool;
reading the tire characters by an optical character recognition (OCR) module connected to the diagnostic tool; and
identifying the vehicle tire by cross-referencing the tire characters captured in the image to a database of vehicle tire information.
